(19) United States
(12) Patent Application Publication
(10) Pub. No.: US 2025/0345708 A1
(43) Pub. Date: Nov. 13, 2025

(54) TRUSTLESS GAMING PLATFORM

(71) Applicant: Kishore Swaminathan, Willowbrook, IL (US)

(72) Inventor: Kishore Swaminathan, Willowbrook, IL (US)

(21) Appl. No.: 19/184,715

(22) Filed: Apr. 21, 2025

Related U.S. Application Data
(60) Provisional application No. 63/646,744, filed on May 13, 2024.

(51) Int. Cl. A63F 13/65; A63F 13/792; G06Q 50/34; H04L 9/32

(52) U.S. Cl. CPC A63F 13/65; A63F 13/792; G06Q 50/34; H04L 9/3236; A63F 2300/69

(57) ABSTRACT

A trustless, cryptographic gaming platform is disclosed for facilitating secure, fair, and auditable betting without relying on centralized intermediaries or odds-setters. To bet on the outcome of a future event, a bettor submits a cryptographic stand-in of the bet instead of the actual bet. When the event's outcome is established, all bets are revealed, verified against their stand-ins, and the wagered amounts are apportioned among winners according to an apportionment scheme that the bettors agreed to.

### CROSS-REFERENCE TO RELATED APPLICATIONS

This application is a Continuation-in-Part of U.S. patent application Ser. No. 17/979,328, which claims the benefit of U.S. Provisional Patent Application 63/283,959. This application also claims the benefit of U.S. Provisional Patent Application 63/646,744. The aforementioned applications are hereby incorporated by reference in their entirety.

### FIELD OF INVENTION

This invention is in the fields of gaming and information security. It describes systems and methods for implementing a trustless gaming platform in which bettors' bets are cryptographically hidden until specific gaming events occur.

### BACKGROUND

At present, most betting involves bookies and odds. Typically, a bookie organizes a bet about a future outcome and offers bettors “odds”—i.e., payout ratios—for different outcomes, typically based on the inverse of the probability of a given outcome.

There are several problems with odds-based betting for both bettors and bookies. From the bettors' standpoint, a bookie has full visibility into the bettors' predictions and wagered amounts. Hence, the bookie can continually alter the odds offered to bettors based on ongoing betting patterns. The bookie can also pass information about current betting patterns to a select few who can take hedging positions to minimize losses or maximize gains. Betting information may also be passed on to people who are in a position to affect the outcome of the underlying event itself.

From the bookie's perspective, a black swan—i.e., an extremely unlikely event with a large wager can wipe out the bookie since the payout is a multiple of the wager and not related to the bookie's intake. Further, while a bookie's odds calculation assumes that the number of bets placed is large and statistically significant, this is seldom the case, especially with sports bets involving a home team. Bookies are widely known for placing phantom bets to ensure that there is enough betting diversity to “balance the book.” Practices such as these, borne out of bookies' asymmetric information advantage over bettors, have led to the adage that the house always wins and bookies do not enjoy the best of reputations.

Pari-mutuel betting is an alternate betting scheme typically found in racetracks. In this form of betting, all wagers placed by participants are pooled together into a single collective pot. Unlike traditional betting systems, where bookies predetermine odds, they are dynamically adjusted in pari-mutuel betting based on the total amount of money wagered on each outcome. This means that the odds are not fixed and can fluctuate until betting closes, when the collected wagers are distributed among the winners. Bettors' predictions and wagers are visible to the organizers, who, much like bookies, enjoy the same asymmetric information advantage over bettors and are in a position to exploit the advantage at the bettors' expense. For example, an organizer may place late-stage hedging bets on underrepresented outcomes to increase their share of the winning pot or reduce the relative payout to earlier bettors by placing strategically timed bets that dilute the share of the winnings allocated to those who predicted correctly earlier.

We describe a trustless gaming platform that enables bettors to protect their betting information from bookies, bet organizers, and other bettors.

### SUMMARY

Embodiments of this invention enable bettors to submit a cryptographically modified version of the bet—a cryptographic stand-in or substitute—in lieu of the bet. The stand-in is constructed in such a way that the bet itself cannot be discerned from it, but when the bet is revealed (typically, after the outcome is established), the stand-in can be verified against the bet. Because predictions remain hidden prior to settlement, no bettor, organizer, or third party can place a strategic bet based on others' submissions.

Once the event's outcome is established, the underlying bets are revealed (and the cryptographic stand-in verified to correspond to the revealed bet), and the total wagered amount is apportioned among winning bettors according to the apportionment scheme defined by the game's rules.

The platform supports multiple techniques for constructing these cryptographic stand-ins, including event-locked encryption and hash-based commitments. Depending on a game's configuration, wager amounts may also be concealed. The system is applicable to a wide range of gaming scenarios, including sports betting, financial forecasting, and lotteries.

### LIST OF FIGURES

FIG. 01 depicts the technical environment for an embodiment of the Gaming Platform.

FIG. 02 depicts a high-level technical architecture of the Gaming Platform.

FIG. 03 shows the description of a game implemented on the Gaming Platform.

FIG. 04 depicts a screenshot of a bettor submitting a bet.

FIG. 05 is a functional depiction of an Event Server.

FIG. 06 depicts the 2-stage event-based encryption and decryption process.

FIG. 07 depicts a hash-based proof of a bet, resubmission, and verification.

FIG. 08 shows the description of a simple, untimed game.

FIG. 09 shows the description of a timed game with vector ranges.

FIG. 10 shows the description of a lottery.

FIG. 11 depicts a screenshot of a bettor buying a lottery ticket.

### DETAILED DESCRIPTION

An embodiment of this invention will be referred to as the Gaming Platform or simply the Platform. It is typically realized as one or more software artifacts. Game organizers use the Platform for organizing betting games. A game enables bettors to predict the outcome of some real-world event: e.g., a sports game, the value of a stock at some future date, an election, or even the winning number of a lottery. A wager is something of value that a bettor stakes in support of one's prediction. A bet refers to the combination of a bettor's prediction about a game and the wager amount paid by the bettor in support of the prediction.

We will also refer to a data object as a cryptographic stand-in if it is derived from an underlying value using a cryptographic function such that the underlying value cannot be determined from the stand-in alone, but the stand-in can be used to verify that a disclosed value corresponds uniquely to the original from which the stand-in is derived.

While the outcomes of an event form the basis of the game outcomes, the latter can be more stylized. For example, a game corresponding to a soccer match may combine multiple match outcomes, such as draw, tie, abandoned, etc., into a single game outcome, say, “no-result.” For an event with a continuum of outcomes, say, the year-end price of a stock, the game outcomes could be stylized into ranges such as $40-$60, $60-$80, and greater-than-$200.

The organizer, rather than the Platform, defines the rules of a given game. The Platform provides the tools for organizers to create different types of games with various rules. The rules of a game could encompass, among other things, the time interval during which the betting for the game is open; how the game's outcome will be determined; how the underlying event's outcomes will be mapped into discrete game outcomes; how the payout will be calculated, and so on. The Platform also provides mechanisms to enforce these rules, such as certified timestamps, outcome resolution via oracles, and programmable settlement logic (described below).

### Platform Architecture

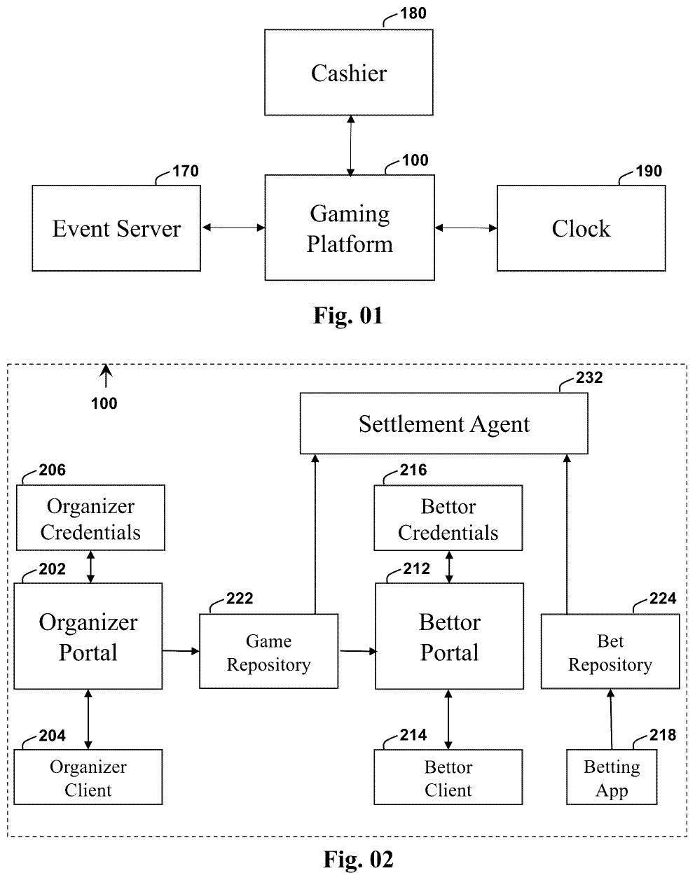

FIG. 01 shows the overall technical environment within which Gaming Platform 100 operates. Platform 100 depends on support from one or more instances of three independent applications: Event Server 170, Cashier 180, and Clock 190, each of which may be implemented using conventional technologies known in the art. The internal operation of these applications is not part of the present invention and is not described in detail here, although their assumed functional behavior is described.

FIG. 02 depicts a high-level architecture of an embodiment of Platform 100. Its server component includes an Organizer Portal 202 that enables organizers to interact with the Platform through Organizer Client 204. Organizers are authenticated with Organizer Credentials 206. They can create games that will be stored in Game Repository 222.

The Bettor Portal 212 enables bettors to interact with the Platform through Bettor Client 214. Bettors are authenticated with Bettor Credentials 216. The Bettor Client has a special or protected component, Betting App 218, which enables Platform 100 to be trustless: 218 encrypts bettors' bets locally, and the server cannot access their predictions. Betting App 218 may be architected as a browser extension, a standalone application, or a client built from open APIs provided by the Platform, enabling bettors to develop or control their own clients.

Betting App 218 enables a bettor's bet to be encrypted in such a way that neither the platform nor any server-side component can access or modify the bet. The bet is encrypted within a local sandbox in 218 and delivered to the Bet Repository 224. It is stored encrypted in 224 until the settlement time of the game associated with the bet.

### Organizer Portal 202

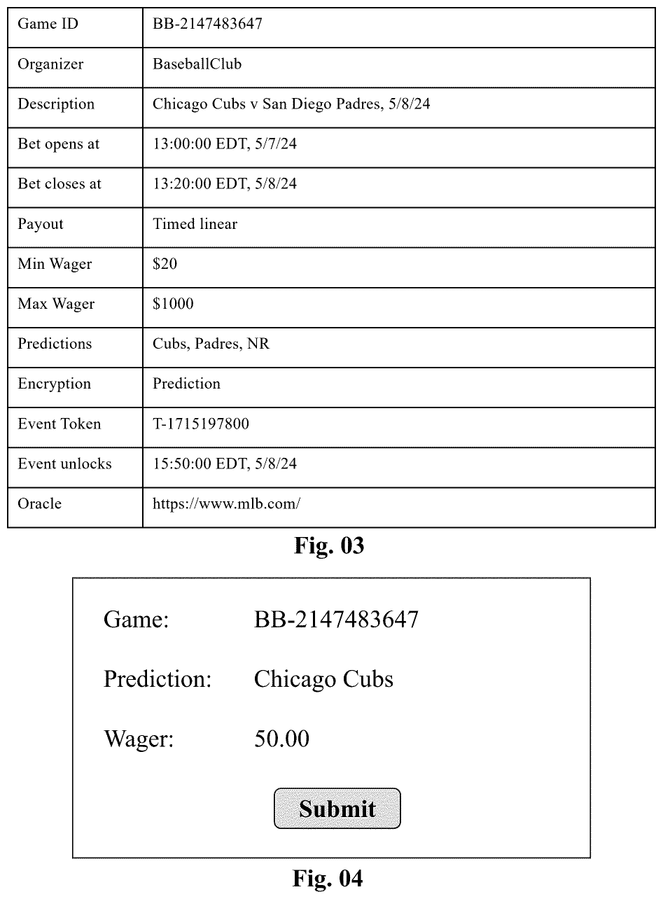

An authenticated organizer can create a game using Organizer Portal 202 and its client 204. FIG. 03 shows the listing of a game from an embodiment: a baseball match between Chicago Cubs and San Diego Padres, scheduled for 13:20 EDT on May 8, 2024. Many of the fields are self-explanatory. We will discuss a few fields that are of special significance.

The game specifies that the payout for the game is time-based and linear. This means that a winning prediction submitted earlier will have a higher payout than one submitted later, and that the decay rate is linear. The Bettor Portal 212 may display the payout model as a graph to explain the payout to the bettor. This field will also trigger the Platform to insert a certified timestamp from Clock 190 into bets submitted to this game as proof of when the bet was submitted; this field will also instruct Settlement Agent 232 to factor this timing model into its payout calculation.

This integration of certified timestamping and prediction concealment—automatically enforced by the Platform—ensures that payout rules tied to timing are verifiable, tamper-resistant, and independent of server-side trust. This combination of features differentiates Platform 100 from both traditional betting systems, where organizers can see all bets and manipulate odds or disclosures, and decentralized prediction markets, which often rely on visible prediction pools and do not hide bettors' selections.

Games where outcomes are not related to the passage of time (say, predicting a coin toss) may ignore time altogether; alternatively, games where information toward the end of the closing time has a large effect on the outcome may use an exponential decay rate to reward the early predictors for the correct outcome much more than the later predictors.

Organizers can use any timing model and can provide hooks for Bettor Portal 212 to communicate the model to the bettors, and plugins for Settlement Agent 232 to implement the model in its payout calculation. For its part, Platform 100 will ensure that an irrefutable timestamp is inserted into any bet related to a game whose payout is based on the time when the bet is submitted; this field will also instruct Settlement Agent 232 to factor this timing model into its payout calculation.

Event token is another important field in the game shown in FIG. 03. The event token specifies the ID of the event whose lock key must be used to encrypt bets for this game. When a bet is submitted for this game, Betting App 218 obtains the lock key for the specified event token from Event Server 170 and encrypts the bet with that lock key. Once locked to an event token, a bet can only be unlocked with that event token's unlock key, which will be released only when that event occurs. See below for more details on event locking and event tokens.

This ensures that neither the organizer nor the bettor can accelerate or delay decryption, making the timing of bet visibility cryptographically enforced. Assume that the shown event token T-1715197800 is set to unlock at 15:50:00 EDT on May 8, 2024, anticipating a game time of 2.5 hours. Since the bet closes at 13:20 and the token unlocks after that, the exact end time of the game does not affect winner determination, since betting closes at 13:20 when the game starts.

The game depicted in FIG. 03 has a discrete set of scalar outcomes—Chicago Cubs, San Diego Padres, and NR (for no result)—and the payout is tied to the accuracy of a single, categorical prediction.

Other games may define outcomes as vectors, allowing payouts to be a function of how close a prediction is to a continuous final value (e.g., predicting where a stock price falls within, say, the $100-$120 range). In such games, bettors predicting within the correct range may receive differing payouts based on proximity to the actual result.

Still other games may use cascaded payouts, such as parlays, where the winnings from one bet automatically become the wager for a subsequent bet. These compound structures allow organizers to define multi-stage betting logic.

The Platform supports these variations through modular rule registration and programmable settlement logic. So long as the rules of a game—scalar, vector, or compound—are properly specified by the organizer and communicated to Bettor Portal 212 and Settlement Agent 232, the Platform can execute them in a trustless and verifiable manner. Naturally, the organizer must also ensure that the rules of complex games are clearly communicated to bettors.

The game of FIG. 03 also specifies an oracle—the website mlb.com—that will be the ultimate authority on deciding what the game's outcome is. Once a game is created, the bettor places a bet with the understanding that these are the rules governing the game. The event's outcome, as revealed by the oracle, is not only crucial to the settlement process, but the fact that this outcome was revealed by the oracle must be preserved for future verifiability. Although the oracle is external to the Platform, its inputs are incorporated in a verifiable manner, such as through digitally signed and timestamped messages by the organizer or the oracle.

### Bettor Portal 212 and Bettor App 218

Bettor Portal 212 and Bettor Client 214 enable bettors to browse the games and place bets. The bettor portal is assisted by Betting App 218, which enables the bettor to encrypt one's bet within a local sandbox. FIG. 04 shows a screenshot of a bettor placing a bet for the game shown in FIG. 03. When the bettor clicks Submit, 218 obtains the lock key for the event token T-1715197800 from Event Server 170 and encrypts the prediction with the lock key (described under Event Locking). Since the predictions are known to be drawn from a small set of possibilities, an intruder can easily guess the prediction with a rainbow table attack; to counter this, embodiments may append a nonce of random bits of arbitrary length to the prediction to increase the entropy of the encrypted prediction to render a rainbow table attack ineffective.

Betting App 218 remits $50 to pay the wager using the bettor's payment credentials to Cashier 180. Cashier 180 returns a voucher with a unique ID for $50, which is cryptographically signed by Cashier 180 to prevent forgery or reuse. Betting App 218 creates the bet and submits it to the server's Bet Repository 224. In one embodiment, such a bet may be submitted as a JSON string such as: {“game”: “BB-2147483647”, “prediction”: encrypted-prediction, “wager”: “$50”, “receipt”: cashier-receipt}.

Since the game is marked as a timed game, Bet Repository 224, on receiving the bet, obtains a certified timestamp for the bet from Clock 190 and inserts the timestamp into the bet. It also checks for double-spending by ensuring that the voucher, with its unique ID, has not been used already in another bet. It then generates a receipt for the bet, which, in one embodiment, is simply a concatenation of the bet and the certified timestamp, digitally signed by Bet Repository 224 using its private key. This allows the bettor to prove that the bet was received and timestamped by the platform.

The prediction embedded in the bet is not visible to the organizer or any other bettor, yet it cannot be changed by the bettor since an encrypted version of the prediction has been deposited with Bet Repository 224. While the wager amount of this bet is visible to the organizer and can even be publicly displayed, the prediction on which this wager is staked is encrypted and not visible to anyone. This design ensures that neither front-running nor strategic timing is possible based on others' predictions.

The current game has chosen to keep the wager amount public, possibly to entice other bettors to bet on this game by publicizing how much has been staked on the game. Visibility settings, including whether wagers are public or concealed, are configurable per game, reinforcing organizer flexibility. As we will see later, it is possible to encrypt bets fully (including wagers), so that neither the predictions nor the wagered amounts are visible until the bets are decrypted.

### Event Locking

A major purpose of the Platform is to ensure that a bet is not visible to the organizer or other bettors and that no new bet can be placed based on information available from existing bets. This creates a dual requirement: bets must remain hidden prior to outcome determination, yet must be immutable after submission. Platform 100 typically depends on event locking or event-based encryption to achieve this requirement.

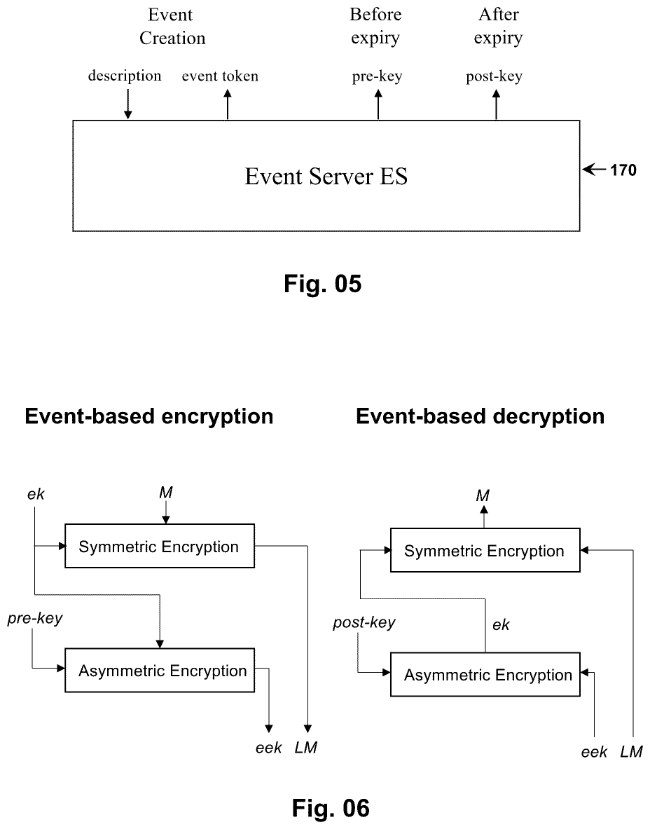

Event locking refers to locking some information through encryption until the occurrence of an event. The event could be a clock event (e.g., 14:00 UTC on Jan. 1, 2024) or a qualitative event (“the eagle has landed”) signaled by an oracle. While event locking is not the remit of this invention, approaches to trustless event locking are detailed elsewhere (e.g., see U.S. Pat. No. 17,979,328), of which a brief description is provided here. An event server, such as 170, which performs event locking, takes an event definition (a time or an oracle for signaling the event) and generates an ID for the event called an event token, as well as an asymmetric cryptographic key pair called a pre-key and a post-key. The two keys are related to each other in such a way that a message encrypted by the pre-key can only be decrypted by the post-key. The pre-key is made freely available at any time, whereas the post-key is placed under the custody of a clock or the oracle, which triggers the release of the post-key after the event has occurred. This is depicted in FIG. 05.

The event server's inner workings—which are not relevant to this invention—can ensure that the event server is trustless; any mechanism that provides a cryptographic key to lock a message until the occurrence of an event and supplies the unlock key once the event has occurred will suffice.

The Betting App 218 takes a prediction (or, if the game requires, the entire bet), appends a nonce (typically a random byte string ranging from 512-2048 bytes) to the prediction to increase its entropy, and encrypts it using the pre-key. Since encryption/decryption with asymmetric keys is inefficient for long messages, in some embodiments, encryption proceeds as follows: the message M to be encrypted is first encrypted with a random symmetric encryption key ek to create the locked message LM. ek is then encrypted with the pre-key of the event to create the encrypted encryption key eek. The encrypted message is thus {LM, eek}. To decrypt the message, LM is decrypted with the post-key to obtain ek, which is then used to decrypt LM to obtain M. These are well-established techniques in encryption and are used by some embodiments of the Betting App 218. The encryption steps are depicted in FIG. 06.

Some embodiments may use a simpler technique—hashing—in Betting App 218 to generate proof of a prediction without revealing the prediction. Hashing algorithms such as the SHA family are well-known techniques for generating cryptographic proofs of content. However, since predictions belong to a small set, predictions are easily guessable from their hash. It is therefore necessary to add a nonce—a random set of bits—to a prediction to make the prediction hard to guess from its hash. In one embodiment that uses hashing for creating a cryptographic proof of bets, Betting App 218 uses a random byte string of length between 512 and 2048 bytes as a nonce, which is appended to the bet after a delimiter such as “#” For example, if the prediction is “Chicago Cubs,” BA 218 will create SHA (“Chicago Cubs #”. nonce) as the proof of the bettor's prediction and send it to Bet Repository 224.

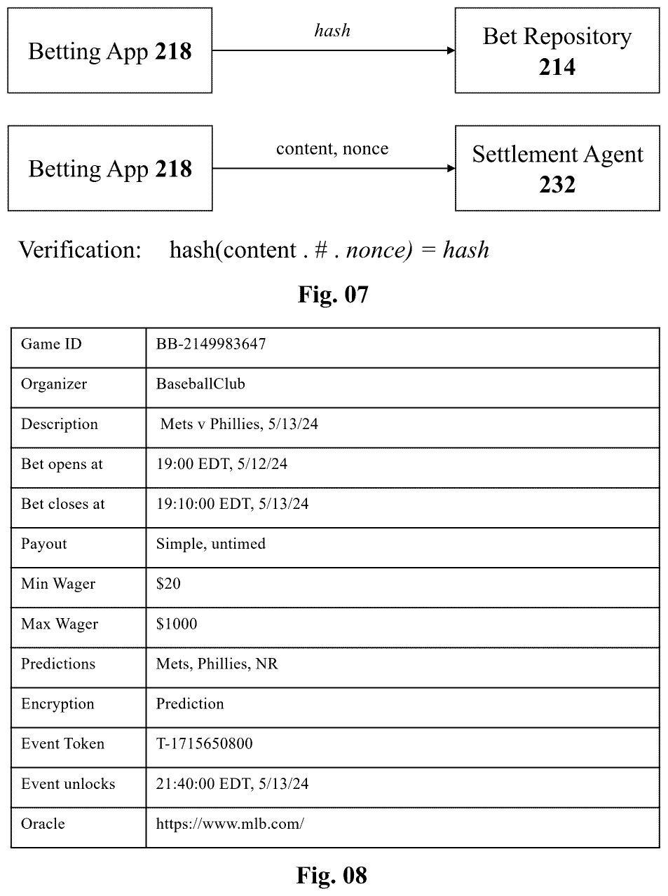

A problem with using hashing for event locking is that it is a one-way function. While the hash of content proves the content, the content cannot be recreated from the hash. Hence, bettors must resubmit their bet (along with the nonce) during settlement to show that the content and the hash tally with each other (FIG. 07). The need for resubmission means that it creates an additional step; many bettors, including winners, may forget to resubmit their bets; and most critically, if the game allows the whole bet (prediction and wager) to be event locked, then losers have no incentive to resubmit their bet, which means that the loser's wagers cannot be recovered by the Settlement Agent 232. Nevertheless, hashing is a viable option for creating a cryptographic stand-in for games in which the aforementioned problems are solvable by other means.

### Cashier 180

Cashier 180 manages money flow across the Platform and acts as the sole clearing agent for vouchers issued by it. In some embodiments, wagers are collected by the cashier and distributed to games or game organizers. In others, Cashier 180 may directly pay the winners as directed by Settlement Agent 232. It may accept different currencies (including cryptocurrencies), provide credit to bettors, charge interest or transaction fees, and perform other banking functions: features that fall outside the scope of this disclosure.

In most embodiments, Cashier 180 accepts cash or cash equivalent in some currency to generate a signed voucher with a unique ID that can be redeemed for a stated amount by the first party that presents the voucher to Cashier 180. When a game does not require or accept encrypted wagers, Betting App 218 submits a plaintext voucher, i.e., a voucher submitted in plaintext without encryption, as part of a bet. Bet Repository 224 verifies that another bet has not already used the voucher.

Games can also accept fully encrypted bets where the prediction, as well as the wager, are hidden such that absolutely no information is available about a game's bets. To create a bet for such a game, when the bettor clicks the Submit button (see FIG. 04), Betting App 218 obtains a voucher from Cashier 180 for the wager amount and creates the bet as follows: {“game”: game-ID, “prediction”: prediction, “wager”: wager-amount, “receipt”: cashier-receipt, “nonce”: nonce} and encrypts the bet before submitting it.

Betting App 218 encrypts the bet with the pre-key of the game's event token and submits the bet to Betting Repository 224. Since the voucher can be inserted into more than one bet and possibly into bets for different games that unlock at different times, some readers may suspect that these vouchers could lead to double spending. However, since there is only one clearing agent for the voucher (namely, Cashier 180) and that clearing agent will only honor the first instance of a voucher presented to it, a voucher cannot be reused. This means that a bettor has no incentive to reuse a voucher in more than one encrypted bet since all but the first bet that unlocks will be rejected as invalid during settlement. So long as there is a clearing house for a voucher, attempts at double spending can be detected and stopped.

### Certified Timestamping and Clock 190

Certified Timestamping, also called Trusted Timestamping, can be implemented using well-known techniques, including standards such as RFC 3161 and X9.95. Its purpose is to certify that a piece of information existed at a particular point in time. In one embodiment, Clock 190 implements certified timestamping without seeing the contents of the submitted bet. When Bet Repository 224 receives a bet b from Betting App 218, it computes a cryptographic hash of the bet, hash(b), and sends the hash, not the bet itself, to Clock 190. Clock 190 appends the current timestamp to the hash, computes hash(hash(b). timestamp), signs the result, and returns the signed timestamp to Bet Repository 224.

Clock 190's signature serves as proof that the bet existed at the specified time, without revealing the bet's contents. Bet Repository 224 then inserts the timestamp into the original bet and stores the timestamped bet in its repository. It also signs the complete stored record and sends it to Betting App 218. Clock 190's signature attests to the time of existence, while Bet Repository 224's signature attests to platform receipt. Together, they provide the bettor with cryptographic proof of when the bet was submitted and what was submitted.

### Settlement Agent 232

When the outcome of the event underlying a game is established, typically by being signaled by an oracle designated by the game, Platform 100 invokes Settlement Agent 232 to initiate settlement. This includes unlocking encrypted bets (if applicable), determining the winner(s), and directing the payout process. In games where hash-based proofs are used instead of encryption, bettors are asked to submit their original predictions (with corresponding nonces) so that the platform can verify the hash-based cryptographic stand-in submitted earlier against the original prediction.

Embodiments may include a library of standard settlement calculators for common types of games. For games with idiosyncratic or complex settlement logic, organizers may provide their own custom calculators. These calculators can be registered at the time of game creation and integrated with Settlement Agent 232 through defined hooks or plugin interfaces.

The following sections describe settlement procedures for different types of games to illustrate the types of tasks performed by Settlement Agent 232 and the range of betting structures that Platform 100 can support. These examples are provided for illustrative purposes and are not intended to limit the types of games that may be implemented on the platform.

### Game 1: A Simple Untimed Game

Imagine a betting game for a baseball match between the New York Mets and the Philadelphia Phillies. The game is untimed and the payout is simple: the total wagered amount will be distributed among the winners in proportion to each winner's wager. The game specifies an event token for the bets to lock their predictions to, and an oracle to signal the outcome. The game details are shown in FIG. 08. The Betting App 218 will encrypt all predictions and each bet will contain an encrypted prediction and a voucher for the wager.

When the game is over and the winner is determined, Settlement Agent 232 is invoked. It retrieves all the bets for the game (based on game ID) and uses the post-key of the event token to decrypt the predictions. Let us assume that m bettors with a cumulative bet of M predicted Mets and p bettors with a cumulative bet of P predicted Phillies and no bettors predicted NR. If the Mets are the winners, then all the Mets predictors get their wagers back and then share, in proportion to their wagers, the total wagers paid by the Phillies predictors. More formally, for each Mets predictor i, the payout will be wi+P·(wi/M), where wi is the wager made by i¹. ¹ In practice, Platform 100 may charge a commission on each bet, part of which may be shared with the game organizers; bettors may be asked to pay the commissions in addition to the wagers or the commissions may be taken out of the wager, thereby reducing the payout. Since these are business issues with well-understood and technical solutions, we will ignore commissions in our calculations.

### Game 2: A Timed Game

Imagine the same game as Game 1—a baseball match between the Mets and the Phillies-but organized as a timed game with a linear payout model. Unlike Game 1, where all winning bets are treated equally, this version rewards correct earlier predictions more than later ones. Assume there are m bettors who predicted the Mets with a total wager of M, and p bettors who predicted the Phillies with a total wager of P. Because the game is timed, each bet includes a certified timestamp tᵢ, inserted at submission time by Platform 100 using Clock 190.

If the Mets are declared the winners, then the total wagers of all losing bettors (those who predicted the Phillies) are distributed among Mets predictors in proportion to their respective wagers. Let t_{c} denote the game's closing time. Then the timed weight of bet i of a Mets predictor with wager wᵢ is [wᵢ·(t_{c}−tᵢ)]/[Σwₖ·(t_{c}−tₖ)] for all Mets predictors k. Hence, the payout¹ for a Mets predictor i is:

$${w}_{i} + P \cdot [ {w}_{i} \cdot ( {t}_{c} - {t}_{i} ) ] / [ \sum {W}_{k} \cdot ( {t}_{c} - {t}_{k} ) ]$$

This formula ensures that each winning bettor receives their original wager plus a share of the losing pool P, weighted by both the size and timing of their wager. Early and larger bets are rewarded more than late or smaller ones, incentivizing prompt, confident predictions.

While the above example uses a linear decay model, other games may benefit from non-linear alternatives. For instance, games involving continuously varying predictions, such as financial forecasts or temperature estimates, might use quadratic or exponential decay to emphasize early bets even more sharply. Platform 100 supports such models using well-established decay functions, and organizers may select or configure the model at game creation. Settlement Agent 232 then applies the selected timing logic automatically during payout.

### Game 3: A Game With Vector Ranges

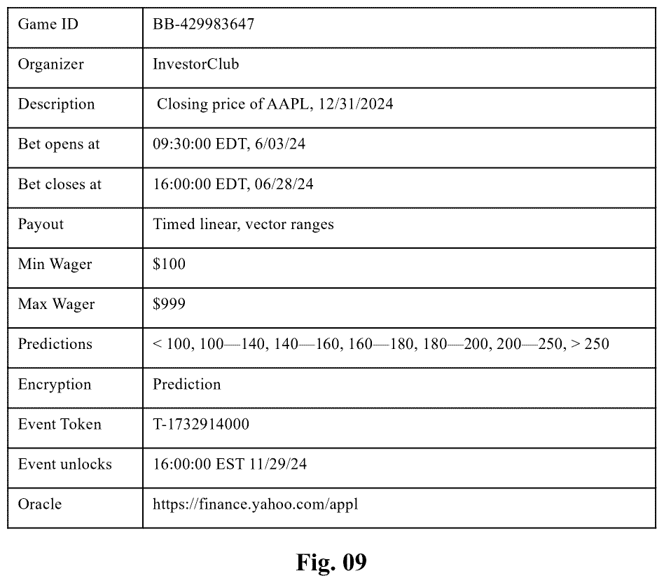

So far, we have dealt with games where the allowed outcomes are scalar. Game 3, shown in FIG. 09, illustrates a hybrid structure combining scalar categories with vector-weighted payouts. In this game, bettors predict the future closing price of a stock, which is grouped into discrete price ranges (e.g., $160-180, $180-200, $200-220). These ranges act as scalar outcome categories. However, within the winning range, payouts are not uniform but weighted according to how close each bettor's prediction is to the actual closing price. This model rewards partial accuracy—closer predictions in the correct scalar range yield higher payouts.

Assume the stock closes at $191. Let the total wager across all bets be X, and the total wagers for all bets in the winning range 180-200 be x. Without vectored weighting, each bettor i in the winning range would receive wᵢ+(wᵢ/x)·(X−x). With vector weighting, the game treats the outcome categories as scalar but differentiates bettors within the winning range using prediction proximity. This ensures that more accurate predictions receive a greater share of the pooled rewards.

One method for implementing vector-weighted payouts is as follows: Let c be the closing price of the stock. For bet i in the winning range, let pᵢ be the prediction and wᵢ be the wager. The deviation of bet i from the average deviation of all bets in the winning range can be calculated as |pi−c|/[Σ(pₖ−c)] and hence the bet's prediction accuracy aᵢ as (1−|pi−c|/[Σ(pₖ−c)]).

Since the payout must be weighted by the wager of each bet, a normalized payout ratio rᵢ for bet i can be calculated as rᵢ=(aᵢ·wᵢ)/Σ(aₖ·wₖ). Finally, the payout¹ for each bet i in the winning range 180-200 is wᵢ+rᵢ·(X−x).

Other vector schemes are possible: for example, an average deviation m from the final stock value across all predictions may be defined as m=(Σ|pi−v|)/n, where n is the number of predictions in the winning range. Predictions whose deviations are within the average may all be considered “correct” and those that have a higher deviation may be excluded from the reward so that the reward for a correct predictor b is w_{b}+(w_{b}/x)·(X−x), where b is defined as a bet for whom |p_{b}−v|<m.

### Game 4: Lottery

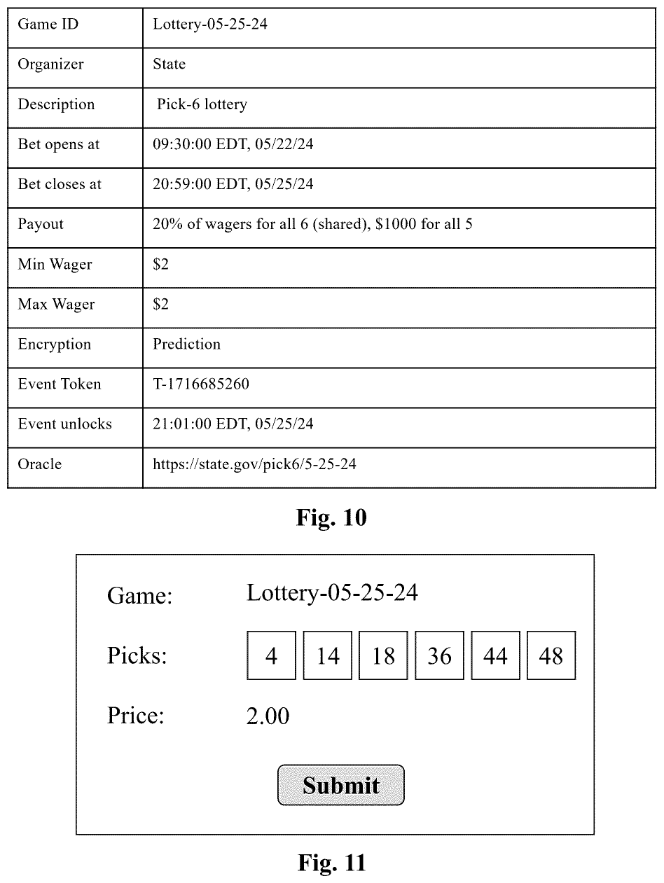

Unlike the previous games that used pari-mutuel payouts, where all losing wagers are redistributed among winners, Game 4, shown in FIG. 10, is a fixed-prize lottery. In this game, bettors each select 6 numbers (e.g., from 1 to 60). Bettors who correctly match all 6 winning numbers share 25% of the total wagers, divided equally among them. Additionally, each bettor who matches exactly 5 of the 6 winning numbers receives a fixed prize of $1000.

In conventional lotteries, bettors' number selections are visible to the organizer. This creates the risk that an unscrupulous organizer could manipulate the winning numbers to favor a specific ticket holder. Platform 100 eliminates this risk by enabling encrypted ticket submission. When a bettor clicks Submit, Betting App 218 encrypts the selected numbers locally using the pre-key of the lottery's event token, which is configured to unlock only after the winning numbers are announced. This guarantees that no one, including the platform or the organizer, can view any ticket's contents before the outcome is finalized, ensuring that winning numbers cannot be selected based on any bettor's ticket. See FIG. 11 for a screenshot of the ticket purchase interface.

During settlement, Settlement Agent 232 decrypts all submitted tickets using the post-key and compares them against the winning numbers as published by the oracle. If one or more tickets match all 6 winning numbers, 25% of the total wagers are equally divided among them. Tickets that match exactly 5 numbers are each awarded $1000. To assist with this process, the lottery organizer may register a custom plugin with Settlement Agent 232 to implement domain-specific rules or prize tiers. All decryption and evaluation occur only after the winning numbers are known, ensuring fairness and auditability.

### Glossary

| Term | Definition |
|---|---|
| Game | A betting context defined by an organizer in which users place |
| | predictions on the outcome of a future event. Each game includes rules |
| | for outcome determination, payout calculation, and visibility. |
| Bet | A bettor's submission comprising a prediction and an associated wager |
| | amount. It is typically a cryptographic stand-in. |
| Wager | The monetary stake attached to a prediction in a bet. Depending on |
| | configuration, the amount may be publicly visible or hidden inside a |
| | cryptographic stand-in. |
| Cryptographic | A data object derived from an underlying value using a cryptographic |
| Stand-In | function such that the underlying value cannot be determined from the |
| | stand-in alone, but the stand-in can be used to verify that a disclosed |
| | value corresponds uniquely to the original from which the stand-in is |
| | derived. |
| Event Token | A unique identifier generated by the Event Server to label a real-world |
| | event. Associated with a pair of asymmetric keys (pre-key, post-key) to |
| | control event-locked encryption. |
| Pre-Key/Post-Key | Asymmetric cryptographic key pair used in event-locking. The pre- |
| | key encrypts data prior to the event; the post-key is released after the |
| | event to enable decryption. |
| Voucher | A digitally signed object issued by Cashier 180 representing a specific |
| | monetary amount. Included in a bet as proof of payment. Each voucher |
| | is redeemable only once. |
| Oracle | An external data source specified by the game organizer to publish the |
| | final outcome of an event. May be implemented as a URL, API, or |
| | signed message, and is used to trigger post-event bet resolution. |

1. A system for organizing betting games in which bettors predict the outcome of future events, the system comprising one or more Internet-connected servers comprising processors coupled to non-transitory computer-readable media storing program instructions that, when executed by the processors, cause the servers to implement:
a betting module configured to receive, from each of a plurality of bettors, a cryptographically encoded bet, wherein:
the cryptographically encoded bet comprises a prediction of the outcome of a future event encoded using a cryptographic function such that the prediction remains concealed until the outcome of the future event is established and the cryptographically encoded bet is verifiable as uniquely corresponding to the established outcome;
a storage module configured to store the cryptographically encoded bets received from the bettors;
a revelation module configured to reveal, for each cryptographically encoded bet, the prediction upon the outcome of the future event being established; and
a settlement module configured to determine, based on the revealed predictions, which of the bets correctly predicted the outcome of the future event, and to apportion a total payout among the winning bets according to a predetermined rule.

2. The system of claim 1, wherein the cryptographic function used to encode the prediction comprises encrypting the prediction using a first cryptographic key associated with an event token, such that the prediction can only be decrypted using a second cryptographic key associated with the event token that becomes available after the outcome of the future event is established.

3. The system of claim 1, wherein the cryptographically encoded bet comprises a cryptographic hash derived from a combination of the prediction and a nonce, and wherein the prediction and nonce are submitted after the outcome is established to verify the hash.
